(19) United States
(12) Patent Application Publication
(10) Pub. No.: US 2024/0322247 A1
(43) Pub. Date: Sep. 26, 2024

(54) POROUS NANO ELECTROLYTE ADDITIVES FOR LITHIUM METAL BATTERIES

(71) Applicant: Nano and Advanced Materials Institute Limited, Hong Kong (HK)

(72) Inventors: Yan Lung WONG, Hong Kong (HK); Shengbo LU, Hong Kong (HK); Chenmin LIU, Hong Kong (HK)

(21) Appl. No.: 18/616,209

(22) Filed: Mar. 26, 2024

Related U.S. Application Data
(60) Provisional application No. 63/492,244, filed on Mar. 26, 2023.

(51) Int. Cl. H01M 10/0567; H01M 10/0525

(52) U.S. Cl. CPC H01M 10/0567; H01M 10/0525; H01M 2300/0025

(57) ABSTRACT

Abstract:

A secondary electrochemical device, includes a high-voltage positive electrode, a negative electrode such as a lithium metal electrode, and an optional separator. A non-aqueous liquid electrolyte includes at least one metal-organic polyhedral (MOP) additive in an amount at least 0.1 weight percent. Typically, an upper limit of the additive is approximately 4 weight percent. The MOP additive has a discrete porous nanocage structure including plural metal clusters with organic ligands forming an accessible cavity with open metal sites and organic functionalities configured to trap water, anions, and transition metal species from the non-aqueous liquid electrolyte. The MOP is further configured to facilitate lithium-ion transport, scavenge free radicals, and stabilize electrode-electrolyte interphases.

### CROSS-REFERENCE TO RELATED APPLICATION

The present application claims priority from U.S. provisional patent application Ser. No. 63/492,244 filed March 26, 2023, and the disclosure of which is incorporated herein by reference in its entirety.

### FIELD OF THE INVENTION

The present invention relates to lithium-based batteries and, more particularly, to porous nano electrolyte additives for lithium metal batteries.

### BACKGROUND OF THE INVENTION

Lithium-ion batteries (LIBs) are now enjoying commercial successes in powering various portable electronics and electric vehicles. However, most LIBs rely heavily on intercalant electrodes which carry limited energy densities. For example, a typical graphite anode possesses a theoretical capacity of 372 mAh g⁻¹ and the state-of-the-art graphite anode-based LIBs only reach a gravimetric energy density of 220 Wh/kg.

In contrast, lithium metal anodes, possessing an ultrahigh theoretical capacity of 3860 mAh g⁻¹, have been considered as an alternative anode material for achieving high-energy-density LIBs (350 Wh/kg or higher). Therefore, lithium metal is an ideal anode material for next-generation energy storage. The development of high-energy-density lithium batteries based on high-voltage cathodes and Li metal anodes is desired in order to serve the increasing demand from wider and eventual full adoption of electric vehicles, as well as the expanding market of intermittent renewable energy storage.

However, the advancement of LIB technologies is now being hindered by a threefold problem: 1) the notorious cathode disintegration (dissolution of transition metal ions from cathodes) upon battery cycling; 2) the severe dendritic lithium formation arising from the highly uneven deposition of metallic lithium on lithium metal anode and 3) the generation of various undesirable side products (e.g., CO₂, HF, PF₅, H₂O) due to the high reactivity between lithium metal and electrolytes and the catalytic effect of detached transition metal species.

Compared to lithium-ion batteries using graphite electrodes, there are safety issues presented by lithium metal batteries. Recharging lithium metal batteries involves electrodeposition of lithium onto itself. This process is problematic since the lithium metal electrodes can easily grow lithium metal dendrites that create internal short-circuits when the dendrites make contact with the cathode. Coupled with flammable electrolytes, this dendrite growth presents a fire hazard.

Reaction of a lithium metal with liquid electrolytes forms a porous, mechanically poor solid electrolyte interphase (SEI) layer on the lithium metal. A uniform and stable SEI can passivate the lithium surface, preventing further reaction; however, typical grown SEI on the lithium electrode surface is inhomogeneous and mechanically fragile. The poor uniformity of the SEI leaves randomly-distributed nucleation sites which trigger dendrite formation; further, the mechanically weak SEI always cracks due to huge volumetric variation of metallic lithium anode during battery cycling. Hence, the fresh lithium metal is repeatedly exposed and react with various electrolyte components or materials suspended in the electrolyte leading to low coulombic efficiencies and fast capacity decay.

FIG. 7 depicts failure of lithium metal batteries due to transition metal ion dissolution, dendrite growth, and side reactions between electrolyte components and electrodes that lead to battery gassing.

Thus, there is a need in the art for developing electrolytes (or additives) for lithium metal batteries, particularly those that promote formation of a stable electrode-electrolyte interphases. The present invention addresses this need.

### SUMMARY OF THE INVENTION

It is an objective of the present invention to provide devices or materials to solve the aforementioned technical problems.

In accordance with a first aspect of the present invention, a secondary electrochemical device is provided. Specifically, the secondary electrochemical device includes a high-voltage positive electrode, a negative electrode, a separator, and a non-aqueous liquid electrolyte. The non-aqueous liquid electrolyte including at least one metal-organic polyhedral (MOP) additive in an amount less than approximately 4 weight percent, the MOP additive having a discrete porous nanocage structure including plural metal clusters with organic ligands forming an accessible cavity with open metal sites and organic functionalities configured to trap water, anions, and transition metal species from the non-aqueous liquid electrolyte, the MOP additive further configured to facilitate lithium ion transport, scavenge free radicals, and stabilize electrode-electrolyte interphases.

In accordance with one embodiment of the present invention, the negative electrode is a lithium metal electrode.

In accordance with another embodiment of the present invention, the positive electrode includes a lithium cobalt oxide (LCO), lithium manganese oxide (LMO), lithium iron phosphate (LFP), lithium nickel manganese cobalt oxide (NMC in the ratios of 5:3:2, 6:2:2, or 8:1:1), lithium manganese iron phosphate (LMFP) or lithium manganese nickel oxide (LNMO or LMNO).

In accordance with one embodiment of the present invention, the MOP additive is present in an amount of 0.1 to 4 weight percent.

In accordance with one embodiment of the present invention, the MOP additive organic ligands include bent-shaped isophthalic acid or its derivatives.

In accordance with one embodiment of the present invention, the MOP metal clusters include copper (Cu) or rhodium (Rh).

In accordance with one embodiment of the present invention, the nanocage structure has a rhombicuboctahedron geometry and has a chemical formula of [M₂L₂]₁₂, in which M is the metal cluster and L is the organic ligand.

In accordance with another embodiment of the present invention, the organic ligands include terephthalic acid or its derivatives, and the metal clusters comprise zirconium (Zr).

In accordance with one embodiment of the present invention, the nanocage structure has a tetrahedral geometry and a chemical formula of [Cp₃Zr₃O(OH)₃]₃L₆, in which Cp is a cyclopentadienyl ligand bonded to Zr(IV) centers.

In accordance with one embodiment of the present invention, MOP additive organic ligands include 1,3-bis(2-phenylethynyl)benzene-based ligands or its derivatives, and the metal clusters comprise copper (Cu) or rhodium (Rh).

In accordance with one embodiment of the present invention, the nanocage structure has a lantern geometry and has a chemical formula of [ML₂]₂, wherein M is the metal cluster and L is the organic ligand.

In accordance with one embodiment of the present invention, the MOP additive organic ligands include biphenyl ligands or its derivatives, and the metal clusters comprise zirconium (Zr).

In accordance with one embodiment of the present invention, nanocage structure has a tetrahedron geometry and has a chemical formula of [Cp₃Zr₃O(OH)₃]₃L₆, where Cp is a cyclopentadienyl ligand bonded to Zr(IV) centers.

In accordance with one embodiment of the present invention, the MOP additive further includes film-forming functional groups and is configured to form stabilized interphases between electrodes and the electrolyte, thereby enhancing the stability of the electrolyte. In some embodiments, the film-forming functional groups are allyl, acrylate, methacrylate, vinyl ether, olefin or nitrile groups.

In accordance with one embodiment of the present invention, the MOP additive is further functionalized by bipyridyl groups capable of capturing transition metal ions leaked from the cathode, contributing to the suppression of transition metal deposition onto metallic lithium anode and improved anode stability.

In accordance with one embodiment of the present invention, the MOP additive incorporates Lewis acidic open metal sites to scavenge Lewis basic impurities from side reactions of the electrolytes with lithium metal, thereby enhancing the purity and stability of the electrolyte.

In accordance with one embodiment of the present invention, the MOP additive participates in the (electro)polymerization of its pendant film-forming functional groups, contributing to the formation of MOP-stabilized SEI layer with higher thermal and mechanical stabilities.

In accordance with one embodiment of the present invention, the MOP additive suppress the dissolution of transition metal species from cathodes by forming a stabilized cathode-electrolyte interphase (CEI), contributing to the suppression of transition metal ions and resulting in the smooth lithium deposition on the metallic lithium anodes.

### BRIEF DESCRIPTION OF THE DRAWINGS

Embodiments of the invention are described in more details hereinafter with reference to the drawings, in which:

FIG. 1 depicts the local coordination environment of the rationally designed linker molecule and Cu(II) center (left); an overview of the cage structure of the inventive MOP-based electrolyte additive with a labelled size of pore aperture (middle); a space-filling model highlighting multifunctional properties of the MOP: the well-defined cavity and the open Cu(II) metal sites for scavenging Lewis basic impurities (right);

FIG. 2 depicts galvanostatic cycling of lithium cobalt oxide cells using a commercial LiPF₆ carbonate-based electrolyte with and without MOP, in which the mass loading of the additive is 2 wt %;

FIG. 3 depicts structures of isophthalate ligands and formation of functionalized MOP materials;

FIG. 4 depicts structures of terephthalate ligands and formation of functionalized MOP materials;

FIG. 5 depicts structures of 1,3-bis(2-phenylethynyl)benzene-based ligands and formation of functionalized MOP materials;

FIG. 6 depicts structures of biphenyl ligands and formation of functionalized MOP materials;

FIG. 7 depicts the threefold root cause leading to the failure of lithium metal batteries: 1) transition metal ion dissolution; 2) dendrite growth from uneven lithium deposition; 3) side reactions with electrolyte components;

FIG. 8 shows combination of various metal clusters and ligands used to form MOP of different geometries and functionalities;

FIG. 9 shows an exemplary MOP structure along with the functions of various components;

FIG. 10 shows how the MOP materials scavenge impurities from side reactions with lithium metal;

FIG. 11 shows how the film-forming functions of MOP materials stabilize the interphase between the electrolyte and lithium metal;

FIG. 12 depicts the results of solubility tests of a conventional MOP and the present MOP in a simple carbonate-based LiPF₆ electrolyte;

FIGS. 13A-13B show that the LMBs adopting the MOP materials of the

present invention have an enhanced coulombic efficiency (CE), in which FIG. 13A depicts a plot of CE versus cycle number and FIG. 13B depicts the average CE at the same cycle number;

FIG. 14 depicts the galvanostatic cycling performance of LCO/Li cells at 2C charge and 4C discharge between 3.0V and 4.4V with or without the MOP materials of the present invention;

FIG. 15 depicts the inductively coupled plasma optical emission spectroscopy (ICP-OES) results of cobalt concentrations in a post-cycled lithium metal anode with or without the MOP materials of the present invention; and

FIGS. 16A-16B display scanning electron microscope (SEM) images of post-cycled lithium metal anodes, in which FIG. 16A depicts a SEM image of the post-cycled lithium metal anodes from control electrolyte without the MOP materials of the present invention and FIG. 16B depicts a SEM image of the post-cycled lithium metal anodes from electrolyte containing the MOP materials of the present invention.

### DETAILED DESCRIPTION:

In the following description, secondary electrochemical devices and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

A solid electrolyte interphase (SEI) is formed on the surface of lithium metal anodes as reaction products between electrolyte components and the reactive lithium anode. The native SEI typically composes of inorganic components such as Li₂O, LiOH, Li₂CO₃ with low ionic conductivity and organic components with low mechanical modulus. The low ion-conducting SEI impedes the lithium-ion transport. Moreover, the poor mechanical stability of the native SEI cannot withstand the huge volumetric expansion during cycling of lithium metal anodes. The SEI suffers from structural cracking and the exposed Li surface reacts with electrolyte components, leading to the continued consumption of electrolyte and rapid capacity fading.

In order to produce a stable and ion-conductive SEI, various additives have been proposed. The use of additives can modify the composition of the SEI to mitigate the side reactions between electrolyte and electrodes. Inorganic additives tend to improve ionic conductivity and provide mechanical strength while organic additives can increase the flexibility of an SEI film. However, no additives have been proposed that both increase ionic transport as well as improve the flexibility and mechanical property.

In accordance with a first aspect of the present invention, the present invention provides secondary electrochemical devices particularly includes electrolyte additives that contribute to the formation of a high-quality electrode/electrolyte interphases which both improve the cycle life of lithium metal batteries and increases battery safety. The term “lithium metal battery,” as used herein, relates to a battery that uses a lithium-metal-containing anode. Examples include lithium metal foils and lithium foils laminated to a current collector such as a copper foil.

The secondary electrochemical device of the present invention is designed for optimal performance and longevity. The device includes a high-voltage positive electrode, a negative electrode, and a separator, all immersed in a non-aqueous liquid electrolyte. The lithium-containing cathode includes lithium oxide and other transition metal oxides. Examples of materials include, for example, LiCoO₂ LiMn₂O₄, Li₂MnO₃, LiNiMnCoO₂, LiMn_{y}Fe_{1-y}PO₄(0≤y≤1), LiFePO₄, or LiNi_{0.5}Mn_{1.5}O₄, although other cathode materials may also be used.

Lithium batteries typically use liquid electrolytes. These electrolytes tend to be flammable organic solvents. These solvents include ethylene carbonate (EC), propylene carbonate (PC), ethyl methyl carbonate (EMC), diethyl carbonate (DEC), dimethyl carbonate (DMC), 1,2-dimethoxyethane (DME), and 1,3-dioxalane (DOL). Various lithium-containing salts, such as lithium hexafluorophosphate, LiPF₆, LiBF₄, or LiClO₄ are dissolved in the solvents. It is noted that the electrolyte additives of the present invention may be used with any non-aqueous electrolyte system, with any known lithium-containing salts and other conventional components.

It is worth noting that the electrolyte utilized in the present invention contains a metal-organic polyhedral (MOP) additive, constituting less than approximately 4 weight percent. The MOP additive exhibits a discrete porous nanocage structure, incorporating multiple metal clusters with organic ligands. This structure forms an accessible cavity, housing open metal sites and organic functionalities meticulously configured to trap water, anions, and transition metal species from the non-aqueous liquid electrolyte.

Importantly, the MOP additive serves a multifaceted role in enhancing the device's performance. It is tailored to facilitate lithium-ion transport, providing an efficient pathway for ions within the nanocage structure. Furthermore, the MOP acts as a scavenger for free radicals, contributing to the overall stability of the device. In addition, the MOP plays a crucial role in stabilizing the electrode-electrolyte interphases, ensuring prolonged and reliable performance.

The secondary electrochemical device may have a negative electrode made of lithium metal, enabling high-energy density configurations. The positive electrode may include lithium cobalt oxide (LCO), lithium manganese oxide (LMO), lithium iron phosphate (LFP), lithium nickel manganese cobalt oxide (NMC in the ratios of 5:3:2, 6:2:2, or 8:1:1), lithium manganese iron phosphate (LMFP) or lithium manganese nickel oxide (LNMO or LMNO). The concentration of the MOP additive is controlled, ranging from 0.1 to 4 weight percent, to achieve the desired balance between enhanced functionalities and practicality.

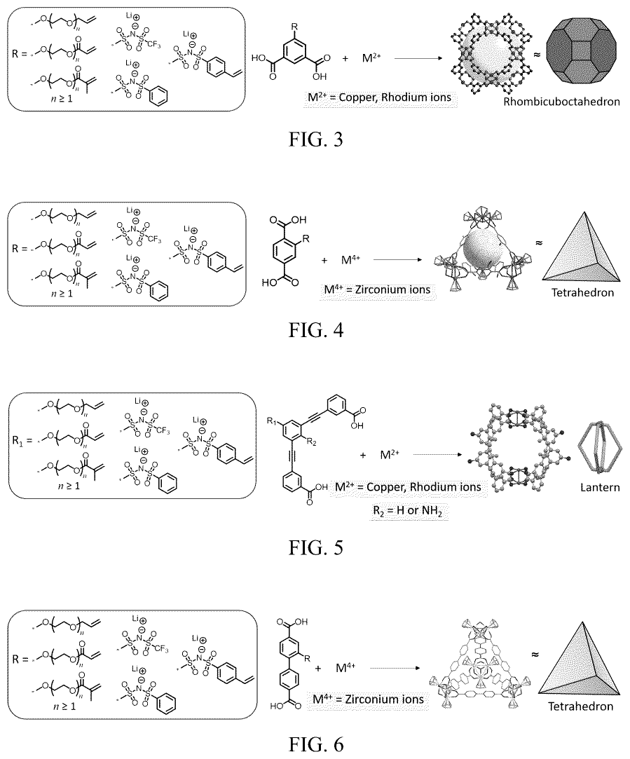

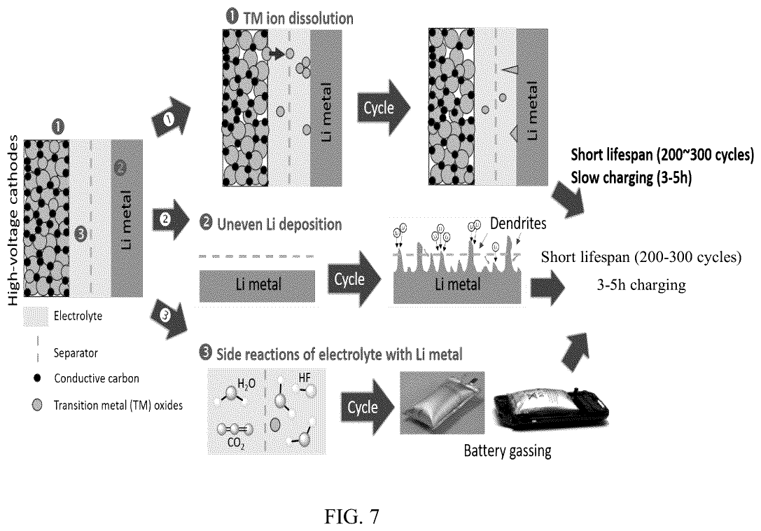

The choice of organic ligands within the MOP additive is crucial for its efficacy. In one embodiment, as shown in FIG. 3, the MOP additive's organic ligands include bent-shaped isophthalic acid or its derivatives. The metal clusters within the MOP may include copper (Cu) or rhodium (Rh), forming a nanocage structure with a rhombicuboctahedron geometry, expressed by the chemical formula [M₂L₂]₁₂, where M represents the metal cluster, and L represents the organic ligand. In an alternative embodiment, as shown in FIG. 4, the organic ligands of

the MOP additive may include terephthalic acid or its derivatives. The metal clusters, in this case, may include zirconium (Zr), forming a nanocage structure with a tetrahedral geometry, expressed by the chemical formula [Cp₃Zr₃O(OH)₃]₃L₆, where Cp represents a cyclopentadienyl ligand bonded to Zr(IV) centers.

In some embodiments, as shown in FIG. 5, the MOP additive organic ligands include 1,3-bis(2-phenylethynyl)benzene-based ligands or its derivatives, and the metal clusters comprise copper (Cu) or rhodium (Rh). Therefore, the nanocage structure has a lantern geometry and has a chemical formula of [ML₂]₂, wherein M is the metal cluster and L is the organic ligand.

In other embodiments, as shown in FIG. 6, the MOP additive organic ligands include biphenyl ligands or its derivatives, and the metal clusters comprise zirconium (Zr). In this case, the nanocage structure has a tetrahedron geometry and has a chemical formula of [Cp₃Zr₃O(OH)₃]₃L₆, wherein Cp is a cyclopentadienyl ligand bonded to Zr(IV) centers.

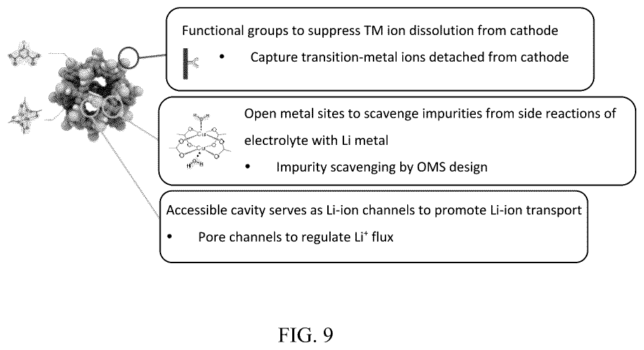

The novel electrolyte additives are based on MOP or metal-organic cages (MOC). The combination of metals and organic components advantageously improves both features of ionic transport and film stability. As seen in FIG. 9, each metal-organic polyhedron includes versatile functional groups to offer multiple advantages. For example, the film-forming functional groups (allyl, acrylate, methacrylate, vinyl ether, olefin, nitrile groups) enable the formation of MOP-stabilized interphases between electrodes and electrolyte. The bipyridyl groups can capture transition metal ion leaked from the cathode, contributing to the suppression of transition metal deposition onto metallic lithium anode. The MOP further includes Lewis acidic open metal sites to scavenge Lewis basic impurities from side reactions of electrolytes with lithium metal. Additionally, the MOP has a structure that includes an accessible cavity that serves as lithium-ion channels to promote lithium-ion transport. The pore channels help to regulate lithium-ion flux.

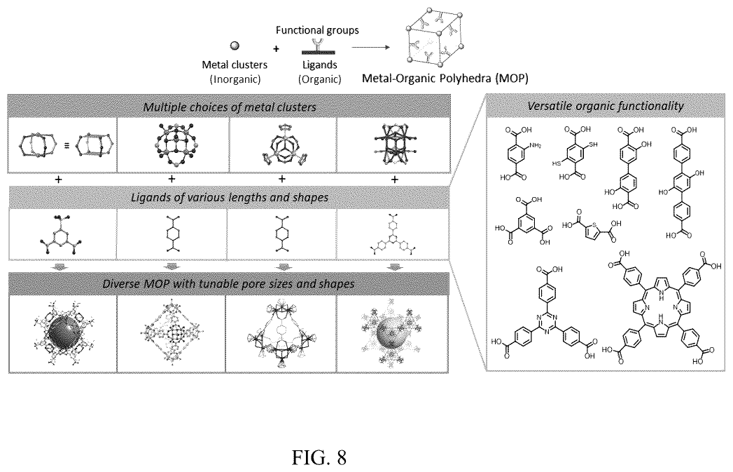

FIG. 8 details the various components that can be used in combinations for form the MOP structures. As seen in FIG. 9, inorganic metal clusters combine with functional organic ligand to form the MOP. Various choices are available for metal clusters including zinc, copper, chromium, rhodium, molybdenum, vanadium, and zirconium. Depending upon the selected ligands, the final product can be made in a wide variety of geometric structures. Importantly, through selection of the metal and ligand, the pore size is tunable which helps to optimize the ion transport in the accessible cavity of MOP.

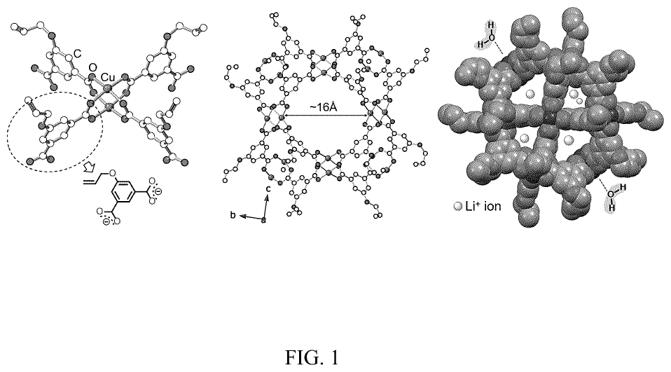

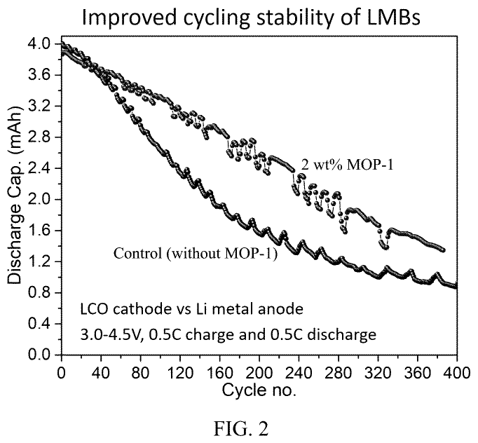

Various MOP materials are constructed from metal clusters and multifunctional organic molecules for use in the present invention. In one embodiment, the additives use a copper-based MOP functionalized with allyl functions. The resolved crystal structure of the MOP material (FIG. 1) features a well-defined cage structure with a rhombicuboctahedron geometry (defining the 24 bent linkers as vertices) and an accessible cavity (16 Å in diameter) with two distinct windows (trigonal windows of 6 Å and square windows of 10 Å in diameter) for regulating Li⁺ ion (size of Li⁺ is 1.8 Å) transportation. The structure additionally traps anions (e.g., BF₄⁻ of 4.5 Å, PF₆⁻ of 5.1 Å, FSI⁻ of 5.4 Å, TFSI⁻ of 7.9 Å) inside the cavity during battery cycling.

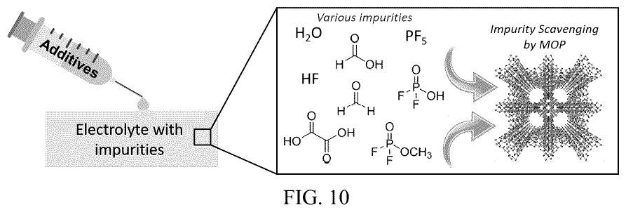

In one aspect, the MOP additives of the present invention scavenge impurities, as demonstrated in FIG. 10. Impurities can include H₂O, PF₅, HF, and other molecules formed from the solvent or from lithium salt components. As seen in FIG. 9, the open metal sites in the MOP molecule capture the impurities. For example, the abundant open metal sites of the paddle-wheel Cu₂(COO)₄ clusters can capture water impurities and anions by coordination interactions. As a result, the water scavenging effect offered by the MOP materials can mitigate the detrimental electrolyte hydrolysis and slow down the rate of cathode disintegration.

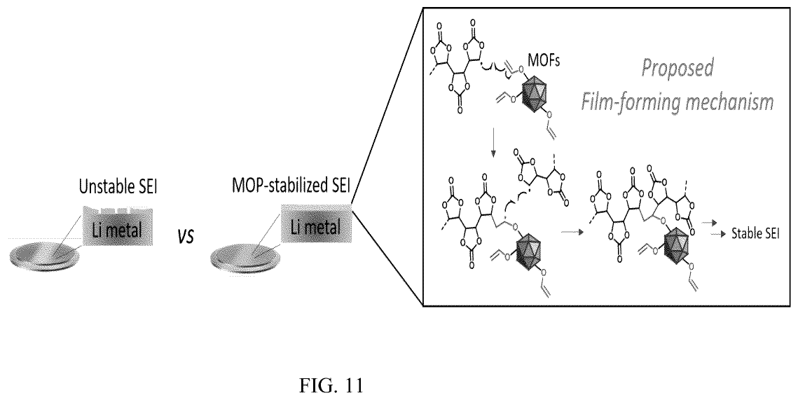

In another aspect, the MOP additives of the present invention participate in high quality SEI formation via (electro)polymerization of its pendant film-forming functional groups to render the formation of MOP-stabilized SEI layers of higher thermal and mechanical stabilities. This process is schematically depicted in FIG. 11. The more robust SEI layers can alleviate the volumetric variation of the Li metal anode and suppress the electron tunneling. The inherently porous structure of the MOP additive can mediate the lithium-ion flux to achieve stable and uniform deposition/stripping processes.

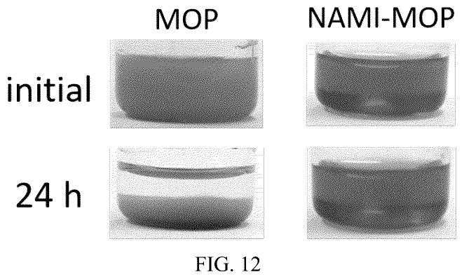

In one aspect, the MOP additives of the present invention possess an improved solubility compared to conventional MOP materials. As shown in FIG. 12, the sample solutions are prepared by stirring a conventional MOP sample or the NAMI-MOP additives of the present invention in the electrolyte at room temperature for 4 hours. Photographs are taken after the samples are at rest for 24 hours. The conventional MOP solid (on the left) exhibits insolubility and poor dispersibility issues. In contrast, a clear blue solution (on the right) is obtained by dissolving the present NAMI-MOP solid indicating the remarkably improved solubility.

In addition to the SEI, the present invention also improves the stability of cathode electrolyte interphase (CEI). The CEI is a heterogeneous multicomponent film that is formed from the oxidative reaction of electrolyte components. Current solutions to address the instability of CEI include electrolyte engineering and artificial methods. However, they fail to maintain a uniform CEI morphology and electrochemical stability when the LMB is coupled with high-voltage cathodes. In contrast, the versatile functionalities of MOP additives of the present invention suppress the dissolution of transition metal species from cathodes by forming a stabilized CEI, resulting in the smooth lithium deposition on the metallic lithium anodes. The MOP-based additives of the present invention enable the formation of more stable CEI with uniform morphology by incorporating electropolymerizable functional groups into the interphases. The inorganic metal clusters of MOP can offer mechanical strength to the CEI.

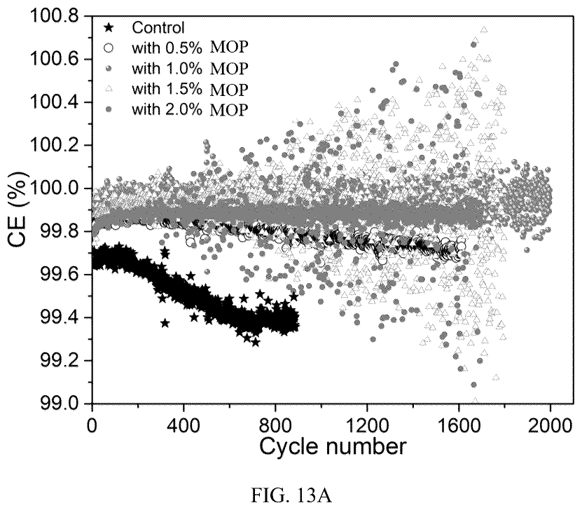

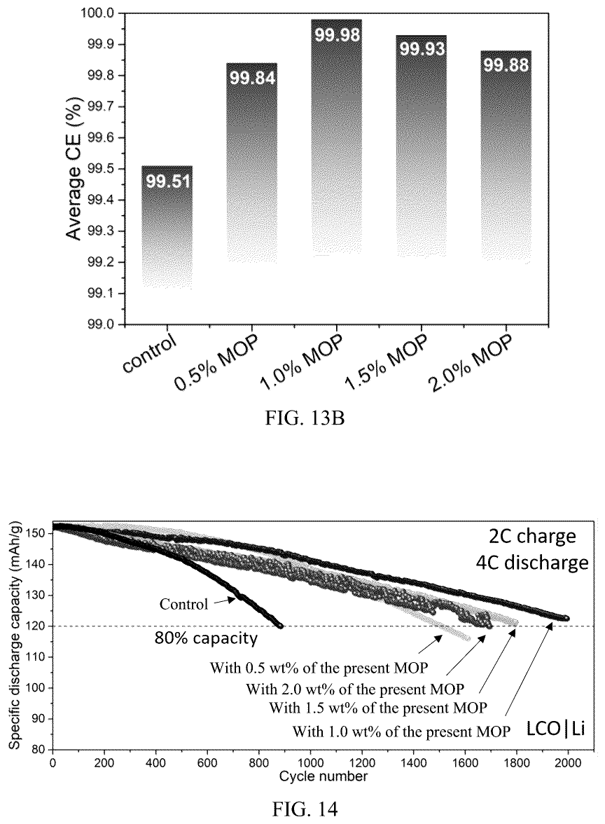

Combined with the MOP-stabilized SEI, the resultant stable CEI can effectively suppress the continuous electrolyte decomposition on the cathode surface and improve the coulombic efficiency (CE). As shown in FIG. 13A and FIG. 13B, with the increase in cycle number, the addition of the present invention's MOP significantly improves the LMB's CE performance.

Considering both cycling stability and the extension of cycle life, the galvanostatic cycling performance is systematically assessed. Illustrated in FIG. 14, lithium cobalt oxide (LCO)/lithium (Li) cells incorporating the MOP additives of this invention exhibit a noteworthy improvement in cycling stability and an extended cycle life, particularly at 2C charge and 4C discharge within the voltage range of 3.0V to 4.4V, in contrast to conventional LCO/Li cells.

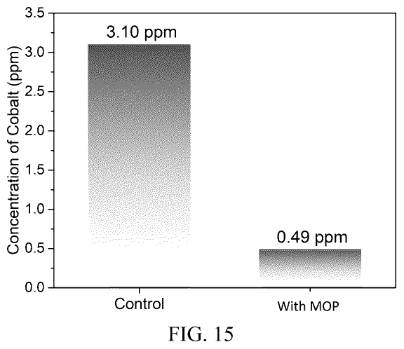

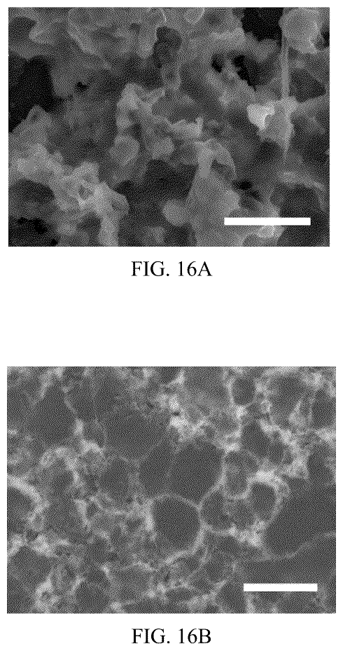

Furthermore, the assessment extends to the post-cycled lithium metal anodes of lithium cobalt oxide (LCO). Specifically, the cobalt concentration on the cycled lithium metal anodes were analyzed using ICP-OES. As depicted in FIG. 15, the post-cycled lithium metal anode without MOP exhibits a higher concentration of cobalt. This increased cobalt concentration is indicative of transition metal ion dissolution from LCO cathodes. In other words, the NAMI-MOP materials can slow down the rate of cathode disintegration or capture the dissolved cobalt species in electrolyte phase. Additionally, examination under a scanning electron microscope reveals that the cycled lithium anode from the control electrolyte lacking the MOP materials of this invention displays a porous and dendritic surface, promoting accelerated side reactions between electrolyte components and reactive lithium metal (sec FIG. 16A). In contrast, the anode from the electrolyte enriched with the MOP materials of this invention results in a flat surface of lithium metal, presenting as a smooth mosaic composed of compact lithium grains (see FIG. 16B).

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5%of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A secondary electrochemical device, comprising:
a high-voltage positive electrode;
a negative electrode;
a separator;
a non-aqueous liquid electrolyte including at least one metal-organic polyhedral (MOP) additive in an amount less than approximately 4 weight percent, the MOP additive having a discrete porous nanocage structure including plural metal clusters with organic ligands forming an accessible cavity with open metal sites and organic functionalities configured to trap water, anions, and transition metal species from the non-aqueous liquid electrolyte, the MOP additive further configured to facilitate lithium ion transport, scavenge free radicals, and stabilize electrode-electrolyte interphases.

2. The secondary electrochemical device of claim 1, wherein the negative electrode is a lithium metal electrode.

3. The secondary electrochemical device of claim 1, wherein the positive electrode includes lithium cobalt oxide (LCO), lithium manganese oxide (LMO), lithium iron phosphate (LFP), lithium nickel manganese cobalt oxide (NMC in the ratios of 5:3:2, 6:2:2, or 8:1:1), lithium manganese iron phosphate (LMFP) or lithium manganese nickel oxide (LNMO or LMNO).

4. The secondary electrochemical device of claim 1, wherein the MOP additive is present in an amount of 0.1 to 4 weight percent.

5. The secondary electrochemical device of claim 1, wherein the MOP additive organic ligands comprise bent-shaped isophthalic acid or its derivatives.

6. The secondary electrochemical device of claim 5, wherein the MOP metal clusters comprise copper (Cu) or rhodium (Rh).

7. The secondary electrochemical device of claim 6, wherein the nanocage structure has a rhombicuboctahedron geometry and has a chemical formula of [M₂L₂]₁₂, wherein M is the metal cluster and L is the organic ligand.

8. The secondary electrochemical device of claim 1, wherein the organic ligands comprise terephthalic acid or its derivatives, and the metal clusters comprise zirconium (Zr).

9. The secondary electrochemical device of claim 8, wherein the nanocage structure has a tetrahedral geometry and a chemical formula of [Cp₃Zr₃O(OH)₃]₃L₆, wherein Cp is a cyclopentadienyl ligand bonded to Zr(IV) centers.

10. The secondary electrochemical device of claim 1, wherein the MOP additive organic ligands comprise 1,3-bis(2-phenylethynyl)benzene-based ligands or its derivatives, and the metal clusters comprise copper (Cu) or rhodium (Rh).

11. The secondary electrochemical device of claim 10, wherein the nanocage structure has a lantern geometry and has a chemical formula of [ML₂]₂, wherein M is the metal cluster and L is the organic ligand.

12. The secondary electrochemical device of claim 1, wherein the MOP additive organic ligands comprise biphenyl ligands or its derivatives, and the metal clusters comprise zirconium (Zr).

13. The secondary electrochemical device of claim 12, wherein the nanocage structure has a tetrahedron geometry and has a chemical formula of [Cp₃Zr₃O(OH)₃]₃L₆, wherein Cp is a cyclopentadienyl ligand bonded to Zr(IV) centers.

14. The secondary electrochemical device of claim 1, wherein the MOP additive comprises film-forming functional groups and is configured to form stabilized interphases between electrodes and the electrolyte, thereby enhancing the stability of the electrolyte.

15. The secondary electrochemical device of claim 14, wherein the film-forming functional groups are selected from allyl, acrylate, methacrylate, vinyl ether, olefin, nitrile groups.

16. The secondary electrochemical device of claim 1, wherein the MOP additive is further functionalized by bipyridyl groups capable of capturing transition metal ion leaked from the cathode, contributing to the suppression of transition metal deposition onto metallic lithium anode.

17. The secondary electrochemical device of claim 1, wherein the MOP additive incorporates Lewis acidic open metal sites to scavenge Lewis basic impurities from side reactions of the electrolytes with lithium metal, thereby enhancing the purity and stability of the electrolyte.

18. The secondary electrochemical device of claim 14, wherein the MOP additive participates in the (electro)polymerization of its pendant film-forming functional groups, contributing to the formation of MOP-stabilized SEI layer with higher thermal and mechanical stabilities.

19. The secondary electrochemical device of claim 1, wherein the MOP additives suppress the dissolution of transition metal species from cathodes by forming a stabilized cathode-electrolyte interphase (CEI), resulting in the smooth lithium deposition on the metallic lithium anodes.
